(19) United States
(12) Patent Application Publication
(10) Pub. No.: US 2017/0236086 A1
(43) Pub. Date: Aug. 17, 2017

(54) SYSTEMS AND/OR METHODS FOR CONTEXT-DRIVEN CONTRIBUTION RANKING

(71) Applicant: Software AG, Darmstadt (DE)

(72) Inventor: Katrina SIMON, St. Ingbert (DE)

(21) Appl. No.: 15/043,772

(22) Filed: Feb. 15, 2016

(51) Int. Cl. G06Q 10/06

(52) U.S. Cl. CPC G06Q 10/06375

(57) ABSTRACT

Certain example embodiments relate to techniques for improving business processes. A model object repository stores aspects, modeled as respective objects, of the business processes. Contribution data—including data representing a contribution corresponding to a proposed change to a business process, and an author thereof—is received, and automatically and programmatically processed by: identifying object(s) associated with the proposed change, and the author; computing, using a set of ranking rules involving static and dynamic contribution relevancy and author expertise, an individual contribution ranking for the associated contribution, the static contribution relevancy relating to how the author is connected to the identified object(s), the dynamic contribution relevancy relating to how the author interacts with business process analysis software components; and applying a set of action handling rules to determine a follow-up event to be executed, the set of action handling rules considering the computed individual contribution ranking for the associated contribution.

### TECHNICAL FIELD

Certain example embodiments described herein relate to techniques for context-driven contribution ranking, e.g., to facilitate Business Process Analysis. More particularly, certain example embodiments described herein relate to the generation of a ranking for each contribution made to a business process based on configurable rules and quantifiable metrics and the subsequent use of such ranking to trigger follow-up actions in or with respect to the associated Business Process Analysis system.

### BACKGROUND AND SUMMARY

Generally speaking, a business process may be thought of as a series of enterprise tasks, undertaken to help create valuable output for an internal or external customer. A defined business process thus may be thought of as providing organizational actions with structure across time, place, and function. Recently, business processes have become a popular means used to describe, analyze, execute, and control operational structures across departments, business units, and even business partners.

Business Process Management (BPM) as a precise computing field may, among other things, aid in the potentially continuous improvement of business processes, e.g., for the sake of overall business success. In this regard, business process models have been established to help specify or formalize processes throughout BPM projects. There are a number of business process modeling language that may be used to develop and deploy business process models. For example, the event-driven process chain (EPC) modeling language has become a de facto standard for conceptual business processes in at least some arenas, and business process modeling notation (BPMN) is a recent industry standard that is gaining traction internationally.

A business process model oftentimes complements process activities by identifying, for example, responsible organizational resources, required input and produced output, supporting software application systems, organizational objectives, risks, etc. Despite being rather easy to use (e.g., even by non-technical process analysts), a business process model oftentimes will include important information on the logical flow, thereby making it a semi-formal requirements basis for technical process implementation. It is at the transformation from conceptual into technical business process models where business process modeling changes the perspective from organizational design into technical engineering.

As a management tool, business process analysis (BPA) goes far beyond core procedural information. Rather, business process analysis may span and include multiple dimensions that interrelate with a business process. The ARIS methodology provided by the assignee of the instant disclosure, for example, illustrates this in the metaphor of a house, with the process constituting the centerpiece, organizational information the roof, functional and data information the walls, and product and service information the basement. FIG. 1 is a diagram of this multidimensional process modeling metaphor. The ARIS platform as a BPA product covers an even broader range of enterprise data including, for example, rules, risks, information technology (IT) systems, key performance indicators (KPIs), etc.

Modeling a business architecture graphically with an enterprise-level BPA tool such as ARIS, for example, may result in structured data repositories reflecting enterprise reality. Doing so also can help lay the groundwork for the performance of business analysis such as, for example, impact analysis, simulation, process costing, personnel planning, dependencies, etc.

Such BPA repositories also eventually may become knowledge pools for entire organizations. For example, standard procedures may be retrieved therefrom and published to a particular audience; IT-systems and their interdependencies can be looked up from a web-based frontend or the like; safety guidelines per process (steps) may be provided to specific roles in specific working situations; entire quality management systems may be fed from such repositories; software projects may use such repositories as primary sources for use case design, requirements gathering, test case design, etc.; and/or the like.

Traditionally, BPA repositories have been filled (i.e., modeled) by a dedicated group of business modelers, and business analysts often have been controlled or at least mentored by a BPA competence center. An end-user, e.g., any employee, has been considered a mere consumer of the information published.

As of now, BPA contributions (requirements, ideas, etc.) typically are gathered in the inbox of a change manager who needs to evaluate and prioritize each contribution, manually. Thus, the change manager typically needs to study each contribution carefully and check for relevance and validity. But evaluating a contribution can be a long and tedious task, requiring not only reading of the contribution but also understanding and reframing it. It may in some instances also be necessary or desirable for the change manager to empathize or otherwise identify with the submission, interact with its author, etc.

Unfortunately, in the BPA world, there currently are no known techniques that for automating the pre-processing of contributions, e.g., to take away from, or at least alleviate this burden for, the change manager in a comprehensive and controlled manner. The inventor has recognized that an automated ranking of all (daily) contributions would help to efficiently allocate the change manager's time, e.g., so that only those contributions that are likely to add value are processed. Priorities pre-assigned by authors to their contributions may be a first step, but they most of the time are likely to be of little help, as they are very subjective and subject to the potential whims of their respective authors who may lack the context for making more informed and accurate assignments.

With employee-driven content contribution to BPA repositories (e.g., ARIS) becoming more widespread, this traditional development and usage pattern is changing. A new trend, “BPA for the Masses,” reflects the potentiality of all employees (and beyond) to not only be consumers of business (process) information, but also to be contributors to it. Consumer-producers in this sense may be “prosumers” in some instances. Indeed, the assignee has observed that BPA customers are increasingly asking for a computer tool that supports simple contributions to (process) models without any modeling but rather from form-based editing or tagging. At the same time, the assignee has recognized that mobile BPA applications could tap a new, full spectrum of business use cases interacting with the BPA backend. For example, mobile technologies may encourage everybody to capture relevant (unstructured) content through a variety of means (e.g., through picture, audio, video, writing, location, performance, and/or other data) and contribute it to complement or improve enterprise models and process models. Giving business users a voice may help increase BPA acceptance and make a BPA repository a more vivid representation of business realities. This trend opens new roads for digitizing enterprises.

Unfortunately, the opportunity for broad-based content contribution in accordance with this new trend raises new management questions, e.g., as the management issues discussed above become potentially even more difficult to deal with. For example, BPA repositories mapping entire enterprises can easily contain more than 10,000 models, adding up to more than 1 million objects, all of which may receive submissions. Furthermore, organizations applying BPA typically have 5,000 to 500,000 employees. If such organizations begin to empower (and maybe even incentivize) their employees to submit changes and lower the hurdles for making such submissions (e.g., so by means of mobile technology, easy-to-use applications, etc.), doing so is likely to lead to thousands of submission every day. Such contributions may be redundant, contradictory, wrong, irrelevant, informal, etc. Therefore, it will be appreciated that mass (e.g., high-volume) contribution could benefit from governance such as, for example, consolidation, evaluation, formal implementation, etc., e.g., to make the best out of all of the received input. If not supported by automation, such massive contribution volumes may require too much in the way of governance resources to be efficient and/or effective. Indeed, manual governance tasks would put the merits of mass content contribution at risk.

With ARIS Process Governance, ideas, requirements, or any other content contribution to the BPA repository is routed by clearly defined organizational rules to (multiple) levels of control. However, the evaluators at the end have to evaluate the contribution manually and without technological support.

Reaching beyond the BPA world, there are at least some approaches to reducing manual evaluation efforts. For example, even though, Wikipedia involves manual evaluation and proofreading of contributions, the so-called New Pages Patrol (NewPP) is its “first line of defense against unwanted pages or for improvement of poorly written or constructed pages” and makes sure that “Wikipedia is not deluged with poor-quality articles and totally inappropriate pages.” Although the NewPP is a kind of automated approach to sorting out unusable contributions, content-specific relevance criteria are defined but not checked in any computational or programmatic manner. For example, only form factors of the text submitted are checked automatically, and there is no semantic or relevance-driven evaluation to support the manual review.

Knowledge management techniques in general have provided some attempts to support the evaluation of participants' contributions, e.g., based on semantic authoring. Although this at first blush seems to be related to the challenge of governance for massive BPA contribution, one difference is that knowledge management typically deals with unstructured data and therefore focuses on different solution approaches that originate in semantics and linguistics. This also applies to approaches that attempt to identify most relevant authors as key persons, for example. Context typically is not considered.

The discipline of “content management” refers to “content Governance” when it comes to maintaining content quality and relevance. This primarily is an organizational setup with defined responsibilities, policies, procedures, and guidelines. At best, governance workflows are used to route content items/tasks among stakeholders, automating content logistics and procedural logic. This unfortunately does not automate the evaluation of the content itself. None of the leading content management tools (e.g., SharePoint, OpenText, Drupal, etc.) exhibit capabilities for supporting content governance, technically.

U.S. Publication No. 2011/0307304 provides some concepts for automating the evaluation and scoring of submissions. While the former is about validity of metadata (such as content size), the latter “scores submissions by comparing the submission to a test data set provided . . . , by a rate of execution or the submission, or by other criteria established by the competition organizer.”

Somewhat similar to what might happen in massive content governance, searching using a web search algorithm or the like typically would deliver too long of a list to be processed by a human being. Therefore, a user might want the list to be ranked by relevancy. There are, however, challenges in determining how to compute this relevancy. In essence, the PageRank algorithm featured by Google computes the relevancy of a web page for a certain search query by its context and interlinkages in the World Wide Web. It is believed that PageRank counts the number and quality of links to a page to determine a rough estimate of how important the website is, with one underlying assumption being that more important websites are likely to receive more links from other websites. Thus, although the general approach of analyzing a structure network of data to determine relevance of individual data items is perhaps somewhat technologically interesting, PageRank targets ranking search results as opposed to contribution volumes.

User profiling (including, for example, examining a users' behavior, interactions, etc., and allowing online community members to be profiled and ranked in terms of experience, competency, or relevancy in general for certain topics) may be of interest, but it has not been researched in the context of structured information contribution.

In general, a majority of both enterprise-level BPA products and content management systems take content governance into account. However, most of the time, they are limited to organizational workflows routing contributions from various levels of evaluation, or to semantic analysis of unstructured content. None of them takes into account the specific characteristics of structured BPA repository content that offers a great potential to leverage massive content governance.

Therefore, massive content governance in the discipline of BPA unfortunately remains a purely manual activity missing any automated, systematic, and quantitative support. The few existing approaches that support content relevancy do so based on semantic analysis of unstructured text without recognizing the authors' profile and general business context in the BPA data network. None of the existing tools available provides an automatic mechanism (e.g., algorithmic approach) to evaluating and ranking BPA contributions based on the author's context and profile.

Certain example embodiments address the above and/or other concerns. For instance, certain example embodiments relate to solving issues that arise from the possibility of “crowd-sourced” contributions to collections of data, e.g., where contributions previously were largely limited to only a few specialists. More particularly, certain example embodiments relate to issues arising with systems having large, yet known contributors, who provide contributions to BPA and/or other objects, which constitute structured data (and not necessarily natural language objects). Certain example embodiments advantageously are able to (automatically) judge the quality of the provided (updated) data.

One aspect of certain example embodiments relates to rather objective measures that can be deduced automatically from the environment and history of a person (contributor) for a particular data object (contribution). In certain example embodiments, even though a combined measurement only provides an estimated value of the provided quality (as the data that is contributed (the contribution object) itself is not necessarily taken into account), the estimation nonetheless helps to cope with the problem of how to manage the masses of contributions that come with crowd-sourced contribution approaches. In extreme cases (e.g., bad rankings), the modifications can be handled automatically (e.g., automatically revoked or disapproved).

Another aspect of certain example embodiments relates to automatically identifying some rather objective means for ranking the quality of a human contribution, certain example embodiments implement rules that can be flexibly adjusted to specific situations, which can be evaluated automatically. In certain example embodiments, these rules may use as objective assessment criteria historic data (e.g., from logs specifying how often the contributor added new data, how many approvals/rejections were made for his contributions, etc.), configuration data (e.g., whether the role of the contributor is appropriate for the contribution object, etc.), the “distance” between the contributor's role and the contribution object (which is possible with the ARIS BPA and/or other platforms), and/or the like.

Another aspect of certain example embodiments relates to flexible but automated and objective assessment of a contribution, with the result of the assessment being passed to an event system or the like that can create further actions depending on, for example, the severity or band of the ranking.

In certain example embodiments, a computer system for improving a business process modeled in accordance with a modeling language is provided. Processing resources include at least one processor and a memory operably coupled thereto. A non-transitory computer readable storage medium tangibly stores a model object repository configured to store aspects of the business process, with each aspect being modeled as an object in accordance with the modeling language. An electronic interface is configured to receive contribution data, with contribution data including data representative of a contribution corresponding to a proposed change to at least a part of the business process and an author of the contribution, and with contribution data being receivable from a plurality of different authors. The processing resources are configured to perform functionality comprising automatically and programmatically processing received contribution data by at least: identifying, from the received contribution data, which object(s) from the model object repository is/are associated with the proposed change, and who the author of the contribution is; computing, in accordance with a set of ranking rules, an individual contribution ranking for the contribution associated with the received contribution data, the ranking rules taking into account at least static and dynamic contribution relevancy as well as expertise of the author of the contribution, the static contribution relevancy being associated with a degree to which the author of the contribution is connected to the identified object(s), the dynamic contribution relevancy being associated with a degree to which the author of the contribution interacts with business process analysis software components; and applying a set of action handling rules to determine, from a plurality of different possible computer-executable follow-up contribution events, a follow-up contribution event to be executed, the set of action handling rules taking into account at least the computed individual contribution ranking for the contribution associated with the received contribution data. Determined follow-up actions also are selectively executed, e.g., using the processing resources.

According to certain example embodiments, for a given contribution the different possible computer-executable follow-up contribution events may include events corresponding to automatic rejection of the given contribution, archival of the given contribution, transmission of data representative of the given contribution to a computer system of a manual reviewer, automatic acceptance of the given contribution, and/or the like. For example, the different possible computer-executable follow-up contribution events may further include an event corresponding to transmission of data representative of the given contribution to a computerized platform by which a community of interested users can subject the given contribution to a community-based inspection procedure. The manual reviewer may be identified as a business process owner and/or a business process object owner, based on metadata stored in and retrieved from the model object repository, and/or the computer system of the manual reviewer may be configured to order, in an inbox-like format, different contributions pending review, based on age and/or computed individual contribution rankings, etc. Individual contribution rankings may be updatable for at least archived contributions, and an update to a given individual contribution ranking may be operable to cause the set of action handling rules to be re-applied.

According to certain example embodiments, the set of ranking rules and/or the set of action handling rules may be objectively determinable and dynamically user-configurable.

According to certain example embodiments, for a given contribution: (a) static contribution relevancy may be based at least in part on a network distance between, and connection type for, the author of the given contribution and the identified objects(s); (b) dynamic contribution relevancy may be based at least in part on how often the author of the given contribution has viewed the identified object(s) within a first time period, how many comments the author of the given contribution has posted within a second time period, how often the author of the given contribution has logged in to a business analysis system associated with the business process within a third time period, how often other contributions made by the author of the given contribution are approved and/or rejected within a fourth time period, and/or whether the author of the given contribution is an original for the identified object(s); (c) expertise of the author of the given contribution may be based at least in part on an amount of time the author of the given contribution has spent in his/her current role, a last appraisal rating of the author of the given contribution, and/or educational level and/or compliance of the author of the given contribution; and/or the like.

According to certain example embodiments, expertise of the author may be based at least in part on data obtained from an external human resources management system.

Corresponding methods and non-transitory computer readable storage mediums tangibly storing instructions for performing such methods also are provided by certain example embodiments, as are corresponding computer programs.

These features, aspects, advantages, and example embodiments may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a diagram of a multidimensional process modeling metaphor;

FIG. 2 is an example BPA data network that shows the linkage between different types of enterprise objections and is used to help describe some of the example techniques disclosed herein;

FIGS. 3A-3C illustrate three instances of this network distance concept, in accordance with the FIG. 2 example BPA data network;

FIG. 4 is a graphical depiction of BPA links between roles and process steps in accordance with certain example embodiments;

FIGS. 5-6 are example screenshots showing sample BPA usage statistics in dashboard format in accordance with certain example embodiments;

FIG. 7 is a block diagram showing, from a logical perspective, an example technical architecture for a BPA system that may be used in connection with certain example embodiments;

FIG. 8 is a block diagram showing a more structure view of a technical architecture that may be used to back the FIG. 7 example BPA system or the like, in accordance with certain example embodiments; and

FIG. 9 is a flowchart showing a method for managing contributions to a BPA system, which may be used in connection with certain example embodiments.

### DETAILED DESCRIPTION

Certain example embodiments described herein relate to techniques for context-driven contribution ranking, e.g., to facilitate Business Process Analysis. For example, certain example embodiments generate a context rank that is computed from multiple input factors and assigned to every contribution item. Based on the business context of the contributing author and the target of his contribution, for example, a ranking for each contribution is computed. This context rank takes into account how much the author is involved in the subject matter to which the author is contributing.

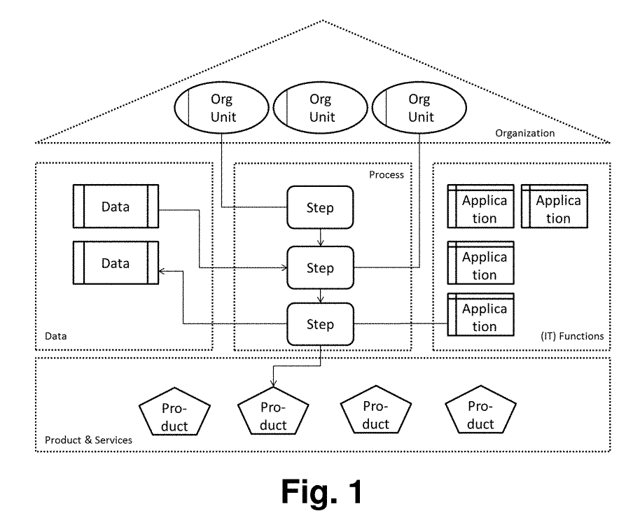

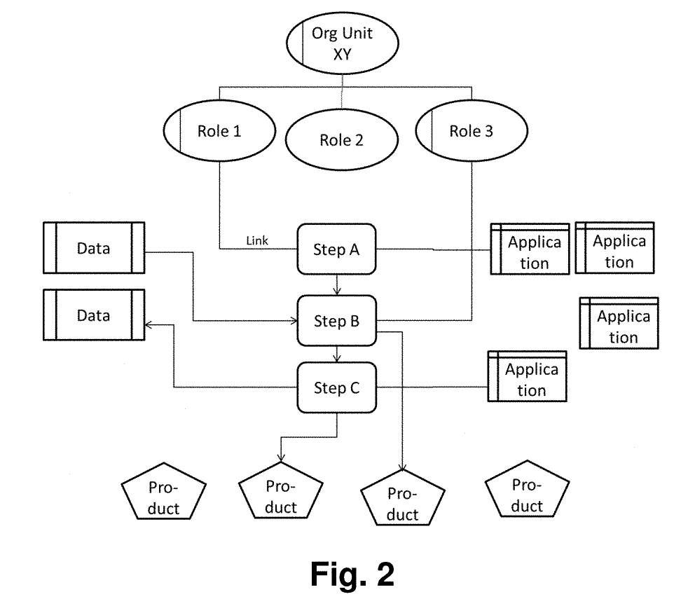

In certain example embodiments, the computational basis for this is the BPA data network itself, as it includes roles and responsibilities in process models. The relevance of a contribution in this way depends at least in part on the neighboring objects in the BPA data network. Consider, for example, FIG. 2, is an example BPA data network that shows the linkage between different types of enterprise objections and is used to help describe some of the example techniques disclosed herein. FIG. 2 follows the general pattern of FIG. 1, in that it reflects for an organization unit the process steps at the center of the model, with organization information being reflected in the roles, functional and data information to the right and left of the process steps, and product and service information provided below the process steps.

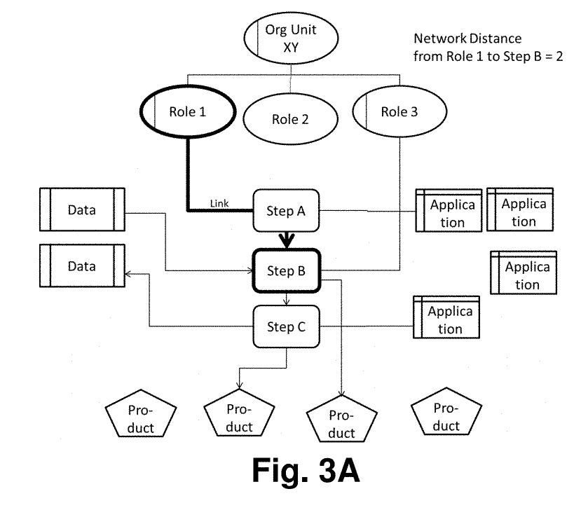

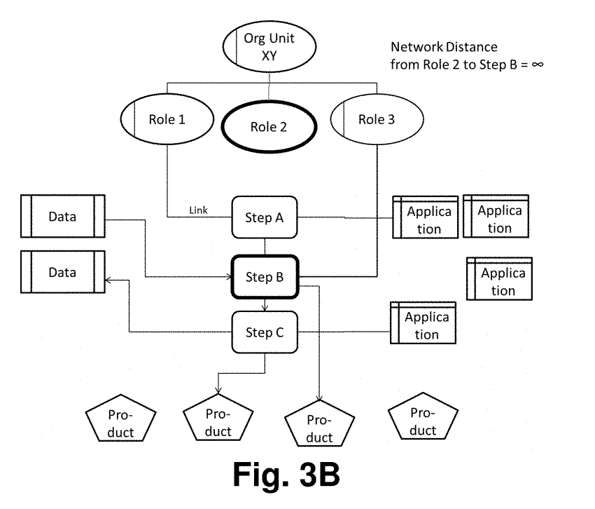

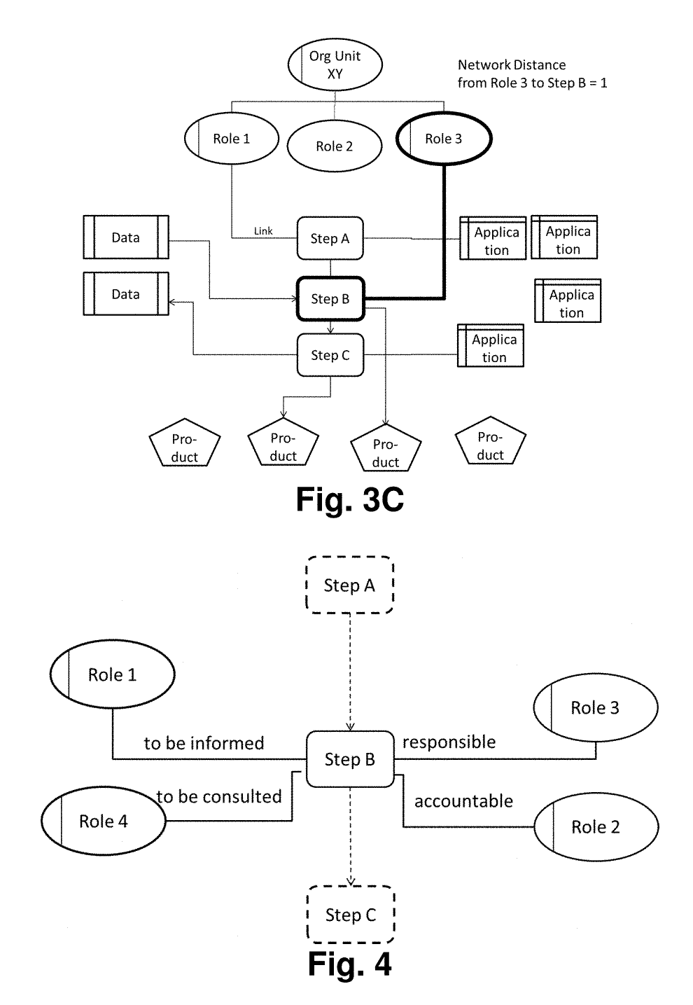

Instead of connected Internet pages that link to each other (as with the PageRank algorithm, for example), the mechanism of certain example embodiments takes into account connected BPA objects that link to each other. The rank may be a function of the “network distance” between the contributor's role and the subject of the contribution in the BPA network. FIGS. 3A-3C illustrate three instances of this network distance concept, in accordance with the FIG. 2 example BPA data network. As shown in FIG. 3A, the network distance from Role 1 to Step B is 2 (i.e., Role 1 is linked first to Step A, and step A is linked second to Step B). As shown in FIG. 3B, the network distance from 2 to infinite or undefined, because there is no path or linkage from Role 2 to Step B. As shown in FIG. 3C, the network distance from Role 3 to Step B is 1 (i.e., because Role 3 is linked directly to Step B).

Additional input may be retrieved by other systems (including, for example, non-BPA systems) such as, for example, human resources systems (e.g., to get a feel for project experience, competencies, career milestones, appraisals, etc.), operational systems (e.g., to get a feel for frequency of conducting a certain task, work performance, error rate, etc.), and/or the like. In addition, or in the alternative, beyond static user context in the BPA network (which may be defined as being relative to the content item, e.g., as illustrated in connection with FIGS. 3A-3C), dynamic user behavior on the BPA platform (including activities such as, for example, viewing rates, commenting, collaboration postings, contribution volumes, feature usage, etc.) may be another valuable source to identify the author's relevancy for a contribution.

Thus, certain example embodiments will not treat all contributions to an enterprise (process) model as being equal. For instance, certain example embodiments may help ensure that contributions to a process by those who are highly involved in that process are ranked much higher than contributions by those who are not. The highest-ranked contribution may automatically activate a governance workflow, taking care of manual evaluations automatically assigned to the relevant process owner. The lowest-ranked contributions may be automatically rejected and sent back to the author with one or more reasons why they have been rejected. Medium ranked contributions may be kept on hold so that they can be looked at by a human during spare time (e.g., vacation or off-season).

As explained in greater detail below, a Contribution Event Controlling Actor in certain example embodiments acts on the ranking, based on well-defined rules. A Contribution Management Inbox in certain example embodiments may receive the gathered information to be analyzed by a human (and in certain example embodiments, this may be implemented as the already existing ARIS Process Board, which is the one-stop solution for all ARIS-related tasks). The Contribution Event Controlling Actor may feed information to the Contribution Management Inbox, in addition to one or more of an EDA, email, and/or other system, for manual and/or automatic actions, e.g., as discussed in greater detail below. Overall, this approach eventually results in a well-ranked list of “best-in-class” contributions that can be better controlled and managed in a world of scarce resources. Important or critical contributions may become more visible and implemented faster, which may eventually result in better business performance.

### Example Implementation

Details concerning an example implementation are provided below. It will be appreciated that this example implementation is provided to help demonstrate the concepts of certain example embodiments, and aspects thereof are non-limiting in nature unless specifically claimed.

In this example implementation, a contribution object (co) is defined as the BPA database object that is to be edited or enhanced by the author's contribution. Editing may affect only a single (e.g., text-based or other) attribute. Enhancing may go beyond simple editing and may include, for example, adding new objects to this object and connecting both objects, adding new documents to this object, and/or the like.

In this example implementation, a contribution author (ca) is the person who submits a proposal to change and/or enhance existing BPA content, e.g., a BPA database object (co). The contribution author may provide this contribution through a digital submission, e.g., using a software application or the like. The contribution author thus is a real person who has one or more assigned organizational roles, with those roles (potentially) being integrated parts of the process architecture as stored in the BPA repository.

In this example implementation, the individual contribution ranking (crk) determines the degree to which the contribution author can be considered a valuable source of knowledge and experience for a specific contribution object.

The general mechanism approaches the quest for the best possible individual contribution ranking (crk) as being a sum of three figures:

crk(ca,co)=scr(ca,co)+dcr(ca,co)+er(ca,co)

In this example implementation, the static contribution relevancy (scr) determines the “network distance” between the contributing author and the contribution object in the BPA database.

In this example implementation, the dynamic contribution relevancy (dcr) determines the contributing author's “degree of involvement” based on the user's behavior, usage and interaction with the BPA software components, etc.

In this example implementation, the expert ranking (er) determines the level of experience and expertise as registered for the contributing author derived from influencing factors that can be retrieved for this author from third-party and/or other systems (e.g., HR systems).

Based on this computed contribution ranking figure, all contributions are ranked immediately when they are submitted digitally. The highest ranked contributions are routed automatically into a digital inbox of the evaluating person, where they are listed in a table-based or other user interface. That user interface in certain example embodiments is programmed and arranged to allow the evaluator to navigate to contribution details, sort along contribution ranking details, and/or the like. The evaluator also may be automatically detected or otherwise identified in the BPA database, as each process model typically holds an attribute that specifies who the responsible process owner is. Thus, a contribution to a certain model that is evaluated with high relevancy can be automatically routed further, e.g., according to predefined rules by the Contribution Event Controlling Actor, e.g., as specified in greater detail below.

This Contribution Event Controlling Actor component triggers contribution events based on the ranking. Depending on the rules, this may result in contributions being rejected automatically, archived for later use, handed over to an ARIS collaboration stream or the like, placed into a manual reviewers' inbox, passed on to an event processing engine, etc. This automatic sorting (and selective initiation of automatic follow-up action) advantageously results in less human workload and more manageable amounts of real review tasks, as described in greater detail below.

The static contribution relevancy (scr) in certain example embodiments is computed by analyzing the BPA database with respect to the network distance between the contributing author's role and the contribution object. The contributing author's role(s) therefore may be looked up as car(ca):

scr(car(ca), co) = −(number of
links(car(ca),co))*RACI(car(ca),co)

A table-based or other lookup or assignment approach may be used to determine or specify how many links connect the author's role with the contribution object, e.g., based on the RACI connection type. For example, in certain example embodiments:

```
RACI(car(ca),co) =
    if the author is RESPONSIBLE then 1
    if the author is ACCOUNTABLE then 2
    if the author is CONSULTING then 3
    if the author is to be INFORMED then 4
    if the author is NOT linked directly with co then 5
```

In a similar vein, FIG. 4 is a graphical depiction of BPA links between roles and process steps in accordance with certain example embodiments. As will be appreciated from the description above and the FIG. 4 example, the links can be of various different types in accordance with the RACI model. It will be appreciated that different example embodiments may assign different link values to the RACI model, use other role distinction paradigms, etc. Different link levels may be linear or non-linear in different example embodiments.

The dynamic contribution relevancy (dcr) in certain example embodiments is computed by analyzing the BPA user log files with respect to the author's recent actions and activities in context of the contribution object (co). For example:

```
dcr(ca,co)′ = viewingRate(ca,co) * collaborationRate(ca) *
    (approvalRate(ca)−rejectionRate(ca)) * loginRate(ca)
if originalAuthor(co) = ca then dcr(ca,co) = dcr(ca,co)′\hat{ }10
    else dcr(ca,co) = dcr(ca,co)′
```

The viewingRate(ca,co) determines how often the contributing author has viewed the contribution object in a predefined time period (e.g., the last 12 months). The collaborationRate(ca,co) counts how many comments the author has posted most recently (e.g., over a predefined time period, with each countable element needing a predetermined length and/or being sufficiently content-related, etc.). The loginRate(ca) determines how often the author has logged into the BPA system in a predefined time period (e.g., the last 12 months). The approvalRate(ca) determines how often the author's contribution have been approved in a predefined time period (e.g., the last 12 months). The rejectRate(ca) determines how often the author's contribution have been rejected in a predefined time period (e.g., the last 12 months). The originalAuthor(ca,co) determines whether the contributing author has being an original author for this contributing object. It will be appreciated that the various time periods may be the same or different as between the different pairs of functions, e.g., in different example embodiments. In certain example embodiments, a common time period may be used for all of the functions.

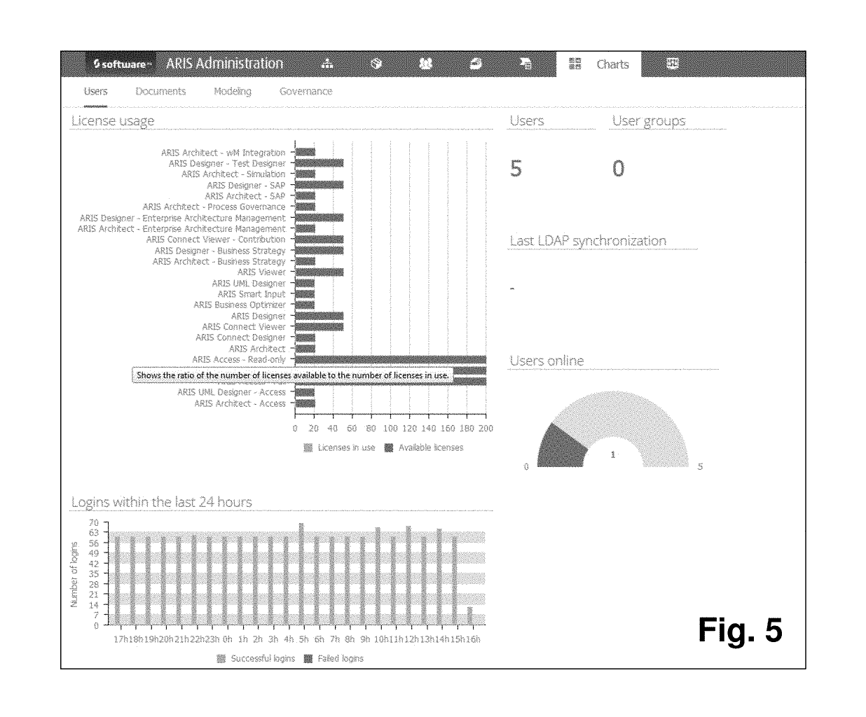

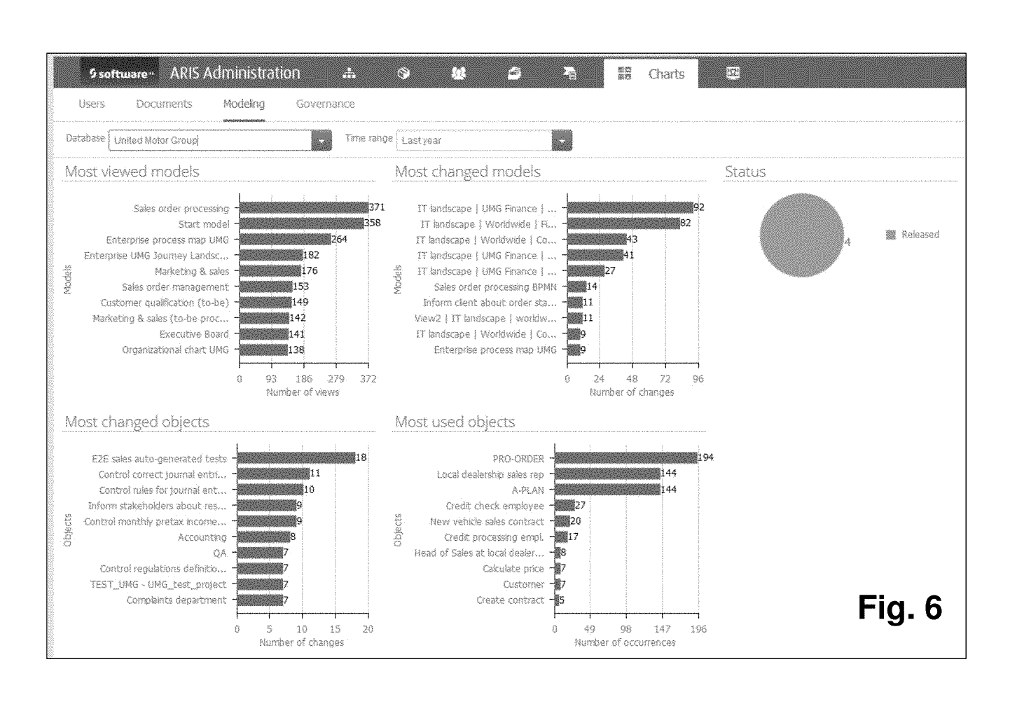

The dynamic contribution relevancy may be prepared by an ARIS development project for user profile management in certain example embodiments. Some of the required data may be provided in the ARIS administration dashboard. In this regard, FIGS. 5-6 are example screenshots showing sample BPA usage statistics in dashboard format in accordance with certain example embodiments. FIG. 5 shows, among other things, the number of logins within a predefined time period (24 hours in this example), as well as license usage, number of users currently online, etc. FIG. 6 shows, among other things, the most viewed and changed models and objects, identifying the number of views and changes, etc.

The expert ranking figure (er) in certain example embodiments evaluates additional insights into the contributing author's qualifications, as they sometimes can be retrieved from the central HR or other system. It may consider seniority in this role and last appraisal rating, as well as whether the person has performed all educational measures as prescribed. For example:

er(ca) = timeCurrentRole(ca) * lastAppraisalRating(ca) *
educationalCompliance(ca)

The appraisal rating may be based on, for example, number of times the user has posted a helpful comment (e.g., as indicated by other users in a community via a five-star ranking system, thumbs up/down rating, and/or the like), etc.

It will be appreciated that the above-described metrics may be computed in the same, similar, or different ways, in different example embodiments.

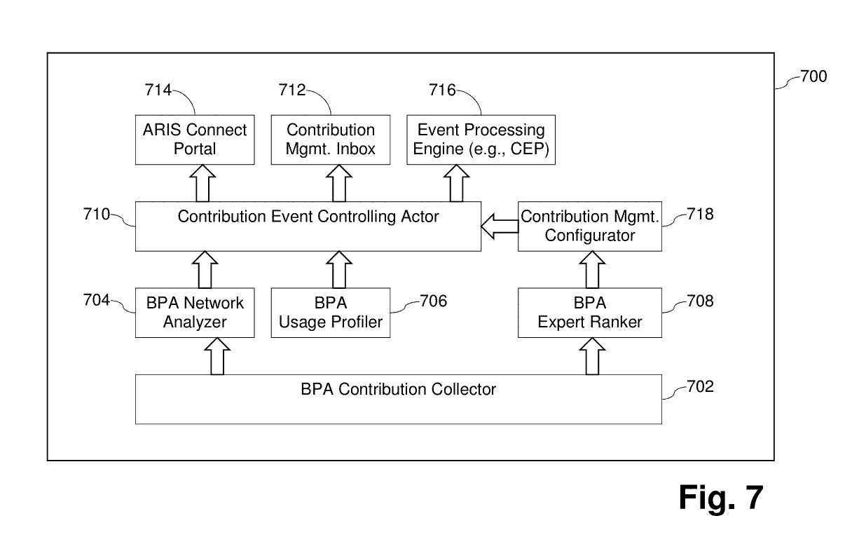

FIG. 7 is a block diagram showing, from a logical perspective, an example technical architecture for a BPA system 700 that may be used in connection with certain example embodiments. The FIG. 7 example system 700 may work in connection with a repository-based or other modeling tool such as, for example, the ARIS platform. Integration with a modeling tool may facilitate the analysis of dependencies between modeling artifacts across process models, as well as usage statistics, among other things.

The BPA Contribution Collector 702 receives contributions that are submitted. The Contribution Collector 702 may, for example, have interfaces connected to one or more electronic or other submission channels such as, for example, a mobile app platform, modeling clients, BPA portal editing, collaboration posts, etc.

The BPA Network Analyzer 704 is based on and operates in connection with the network of modeled objects. If ARIS is used as the modeling tool, the Network Analyzer 704 may operate on ARIS objects that are modeled and stored to a database, e.g., in connection with their respective business processes. The Network Analyzer 704 runs queries against this network of modeled objects in order to compute the value of the static contribution relevancy (scr), for example.

The BPA Usage Profiler 706 consolidates user statistics and puts them in relation to the contribution object in order to compute the value of the dynamic contribution relevancy (dcr), for example. The Usage Profiler 706 thus may have interfaces to BPA-related systems that enable it to determine, for example, how many posts a user has made, how highly rated those posts and/or the user are within the context of the relevant area (e.g., business unit, business, industry, etc.), etc.

The BPA Expert Ranker 708 takes information third-party systems (which are not BPA related and instead might be, for example, HR and/or other systems) as an input, e.g., to determine the proficiency of the contributing author as computed by the expert rank (er). Such information may be used to determine how long a user has been in a given position, with an organization, in the field generally, etc.; what the user's educational qualifications are; and/or the like.

The Contribution Event Controlling Actor 710 is a component that consolidates rankings provided from the Contribution Collector 702, the Network Analyzer 704, and the Usage Profiler 706, e.g., according to predefined rules. These rules may in certain example embodiments be logical, event-driven and/or other rules. In certain example embodiments, the Contribution Event Controlling Actor 710 not only takes into account present data, but also considers rankings over the course of time (e.g., to help determine or infer whether the contributor is a “newbie”, someone who is trending in the direction of providing positive or negative input, someone whose knowledge is dated or recently “refreshed”, etc.). The computational combination of at least these factors leads to the overall contribution ranking, e.g., as discussed above. The mechanism concerning what to do with a given contribution may be defined by pre-configured rules. Some or all of the following and/or other example rules may be used in certain example embodiments:
Contributions that do not comply with some formal rules (e.g., English language, offensive vocabulary, etc.) are automatically rejected and discarded. The author automatically receives a predefined rejection email or other notification. This type of rejection may negatively affect the ranking of future contributions by this particular author. That is, certain example embodiments may include logic that updates the author's score based on number of approvals, rejections, etc. The granularity may be customized such that approvals following manual review provide positive points, automatic approvals provide a higher number of positive points, automatic rejections provide negative points, etc.
Contributions that remain below a certain predefined ranking value threshold are automatically rejected with some automatically generated reasoning. For example, they may be sent back to the author via email or the like and archived in a database.
Contributions that are above a certain predefined ranking value are marked as extremely relevant and pushed into the Contribution Management Inbox 712 (described in greater detail below), e.g., for final review by one final human managerial evaluator (who may in some instances be the process owner or other suitably empowered person).
Contributions that are affecting an object of a process that is marked as “collaborative” in ARIS or other modeling tool, are automatically routed into the collaboration stream of the relevant process model, where the community of legitimate users can discuss this contribution collaboratively. It will be appreciated that this approach helps demonstrate the potential usefulness of automated ranking.
Contributions that achieve only medium ranking results are to be reviewed and evaluated by two office workers before they are further routed to a manager who is eligible to approve or reject. In this case, contributions are routed to those two office workers Contribution Management Inbox 712 instance, first before they are passed on to the manager's inbox instance.
Contributions whose partial rankings are contradicting (e.g., high static contribution relevancy, low expert ranking, etc.) are collected on a per-object basis and forwarded to an office worker's Contribution Management Inbox 712 instance. They may be bundled in predefined numbers (e.g., bundles of three), which may help simply human review work.
Contributions that are authored by the process owner are automatically delegated to a substitute (thereby segregating duty and providing a more independent check). They may, for example, be routed to the substitute's Contribution Management Inbox 712 instance automatically.

The Contribution Management Inbox 712 is a GUI component that presents personal contributions (e.g., an edited process step description that has been ranked by the relevant components (e.g., the Network Analyzer 704, the Usage Profiler 706, and/or the Expert Ranker 708) so as to have scr=−25000, dcr=4000, ecr=25200, with an overall content ranking of crk=4200 (which is above a predefined critical of, for example, 4000). It will be appreciated that these thresholds are provided for this example and need not necessarily be the same. That is, these thresholds may be freely chosen or otherwise specified in different example embodiments. In certain example embodiments, these thresholds may be computed based on an evaluation history, e.g., such that the system learns over time which values are more important than others, where thresholds lie, etc. Reaching these levels triggers the Contribution Event Controlling Actor 710 to push the contribution directly into the Contribution Management Inbox 712. The message may be enhanced by the analysis results from Expert Ranker 708 and optionally sorted by contribution rank, e.g., as a table for the evaluating user, who personally may evaluate the contribution or delegate the evaluation. The Contribution Management Inbox 712 may be implemented as a standalone GUI, integrated into a modeling tool, displayed in an email or email like inbox (e.g., in its own sortable folder in a commercially available email client), etc. Each incoming contribution may cause a separate message to be delivered to the relevant reviewer, e.g., to prompt the review. This separate message may be an email message, voicemail message, text message, and/or the like.

ARIS Connect Portal 714 The ARIS Connect Portal 714 can create a collaboration stream for contributions in a process model that has been marked as “collaborative” or the like, e.g., as alluded to above. This may be triggered by the Contribution Event Controlling Actor 710 for all contributions to a process model that is marked as being collaborative. Here, a community of authorized users can discuss the collaboration and decide on whether it should be rejected or approved, in a collaborative manner.

All pre-qualified contributions may be considered an “event” that is passed on to an Event Processing Engine 716. The Event Processing Engine 716 may be a complex event processing (CEP) engine or the like, and it may combine events from multiple resources. For example, if multiple contribution events to one business process coincide with severe quality incidents in the same business process model, there may be an urgent need to re-engineer the process in its entirety.

The Contribution Management Configurator 718 is a GUI component that helps configure the computational rules (see the above for example rules) that define the actions that the Contribution Event Controlling Actor 710 is to trigger, e.g., based on certain contribution ranking values.

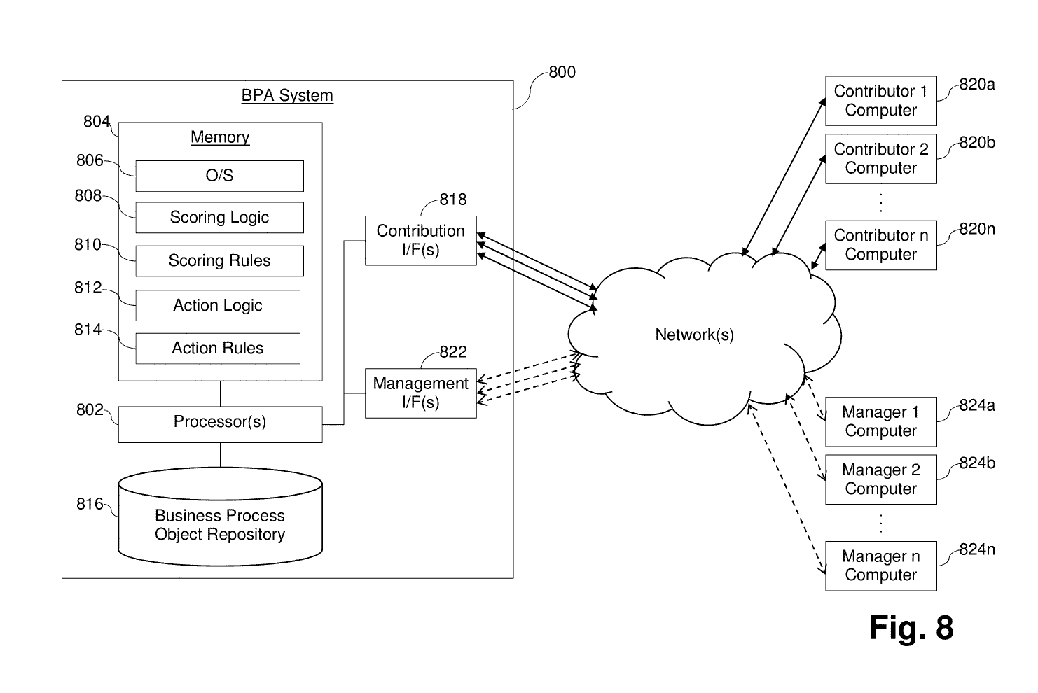

FIG. 8 is a block diagram showing a more structure view of a technical architecture that may be used to back the FIG. 7 example BPA system 700 or the like, in accordance with certain example embodiments. The physical view of the BPA system 800 includes processing resources including one or more processors 802 and a memory 804 (which may include transitory and/or non-transitory computer readable storage media). The memory 804 includes, for example, an operating system 806 that enables the BPA platform to operate. Scoring logic 808 and scoring rules 810 are applied based on information received from the Contribution Collector 702 and may be thought of as backing some or all of the Network Analyzer 704, the Usage Profiler 706, and the Expert Ranker 708. Action logic 812 and action rules 814 may specify, for example, how the Contribution Event Controlling Actor 710 is to operate. This may include, for example, when and how to consider scores, specifications of thresholds that cause different actions to be taken (e.g., sending contributions out for approval/rejection, automatically approving or disapproving rules, sending return messages, etc.), and/or the like. In certain example embodiments, the scoring rules 810 and/or the action rules 814 may be user- or system-defined.

The processor(s) 802 also is/are in communication with a business process object repository 816. The business process object repository 816 stores representations of one or more business processes (models), as well as the objects that help define the one or more business processes (models). The business process object repository 816 may include metadata for objections and/or processes, identifying owners, past and/or present contributors, lists of possible contributors, etc. Newly proposed contributions may be at least temporarily stored in the business process object repository 816 or elsewhere, in different example embodiments. Metadata including ranking or scoring information, contributor, time of submission, time for consideration, etc., may be associated with newly proposed contributions.

The processor(s) 802 also may be connected to one or more interfaces. For example, as shown in FIG. 8, the contribution interface(s) 818 receive contributions from contributors who use contributor computer systems 820a-820n. It will be appreciated that the contribution interface(s) 818 may receive data via a dedicated application programming interface (API) that facilitates messaging via a mobile or other software application, via email, via text message, and/or the like. The computer systems 820a-820n may be thought of as including personal computers (e.g., desktops, laptops, notebooks, ultrabooks, etc.), mobile devices (e.g., smartphones, PDAs, tablets, etc.), and/or the like. In addition to receiving information about contributions, the contribution interface(s) 818 may be used to provide messages to the contributors. Such information may indicate, for example, that a proposed contribution has been received, that a proposed contribution has been accepted or rejected, that a proposed contribution is pending approval, etc. Status information may be provided to indicate, for example, current rankings, whether a proposed contribution has been sent out for review, who is reviewing a proposed contribution, how long until a proposed contribution may be maintained before “timing out” and being rejected, etc.

The management interface(s) 822 may provide information to one or more manager computers systems 824a-824n, e.g., altering reviewers that they have manual review tasks to complete, that a change has been automatically approved or disapproved, etc. Similar to the above, such information may be sent via a dedicated API, email, text message, and/or the like, and the computer systems 824a-824n may be thought of as including a broad range of device types (e.g., including at least those specified above).

Interfaces to other external system such as, for example, a human resources system, modeling community, and/or the like, also may be provided, for the BPA system 800.

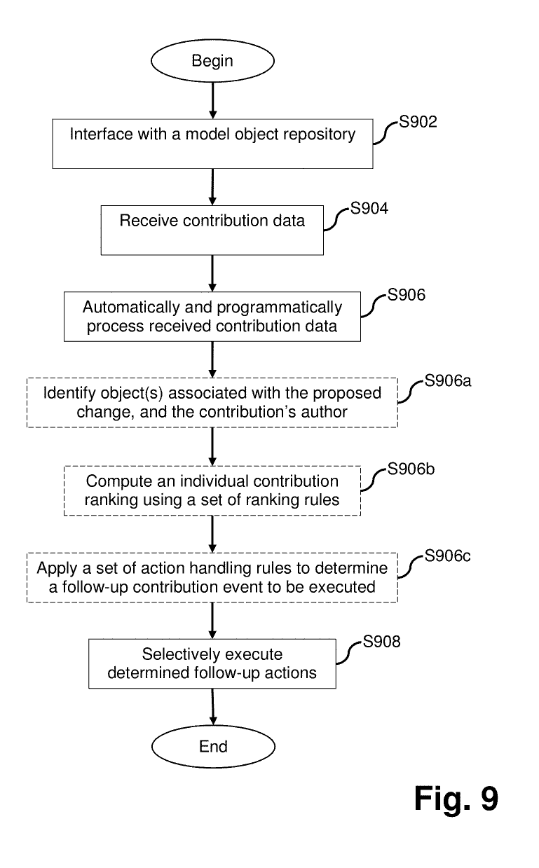

FIG. 9 is a flowchart showing a method for managing contributions to a BPA system, which may be used in connection with certain example embodiments. That is, FIG. 9 shows an example method for improving a business process modeled in accordance with a modeling language. The method includes (step 902) interfacing with a model object repository configured to store aspects of the business process using processing resources including at least one processor, with each aspect being modeled as an object in accordance with the modeling language. Contribution data—including data representative of a contribution corresponding to a proposed change to at least a part of the business process and an author of the contribution—is received (step 904). The contribution data is receivable from a plurality of different authors. Received contribution data is automatically and programmatically processed (step 906), using the processing resources, by at least: identifying, from the received contribution data, which object(s) from the model object repository is/are associated with the proposed change, and who the author of the contribution is (step 906a); computing, in accordance with a set of ranking rules, an individual contribution ranking for the contribution associated with the received contribution data (step 906b), with the ranking rules taking into account at least static and dynamic contribution relevancy as well as expertise of the author of the contribution, with the static contribution relevancy being associated with a degree to which the author of the contribution is connected to the identified object(s), and with the dynamic contribution relevancy being associated with a degree to which the author of the contribution interacts with business process analysis software components; and applying a set of action handling rules to determine, from a plurality of different possible computer-executable follow-up contribution events, a follow-up contribution event to be executed (step 906c), with the set of action handling rules taking into account at least the computed individual contribution ranking for the contribution associated with the received contribution data. Determined follow-up actions are selectively executed using the processing resources (step 908).

### Example Use Case

The following example use case provides a concrete example use case, demonstrating how the techniques of certain example embodiments may operate. It will be appreciated that there are many other use cases covered by the technology disclosed herein, and that the data provided below is fictitious and provided for understanding purposes only. A contribution to an enterprise process model is processed as follows:

In this example, in organization ABC, all enterprise processes are stored in the BPA repository. Each process step comes with safety instructions. Those safety instructions are provided as prompts to employees' mobile devices, whenever those employees are about to perform a process step.

Mr. White, a team member on the organization's shop floor who has a lot of experience in his role, is wondering why the most dangerous process step in the production chain, WELDING DOOR COMPONENTS, comes with a generic safety instruction. He reviews the process model and recognizes that this process step has only a very generic, non-specific safety instruction attached. Therefore, Mr. White submits a proposal for more detailed safety text, which he illustrates with a short instruction video taken with his mobile phone's camera. The proposed contribution in this case includes the text and the short instruction video, and it is submitted through an app running on Mr. White's phone.

Once the contribution is submitted, it is automatically checked against the various criteria. First, the BPA network analyzer identifies Mr. White as a “production hall senior worker”, e.g., based on information stored as an enterprise role object in the BPA database. The contribution item is automatically recognized as referring to a process step object stored in the same BPA database. Analyzing the network distance between the role and the process step provides insights into Mr. White's network distance. His current role is assigned to other, more challenging process steps downstream on the production chain. Thus, his network distance is rather high. However, the history analyzer reveals that Mr. White used to work in another role more than 5 years on this process step with this machine. This adds credibility to his contribution and accordingly enhances the ranking of the contribution significantly, even despite a rather moderate or even high present network distance. The static contribution relevancy (scr) thus is computed as follows:

scr(car(Mr. White), WELDING DOOR COMPONENTS) = scr(welder,
WELDING DOOR COMPONENTS) = −(number of links(welder,
WELDING DOOR COMPONENTS)*RACI(welder, WELDING DOOR
COMPONENTS)) * 1000=−5*5=−25000

Second, the BPA Usage Profiler provides insights into Mr. White's interactions with the BPA systems. It computes that Mr. White was NOT been the original author of the process step; has viewed this process step in the last 12 months ONCE; initiated more than 50 collaboration comments in the last 12 months; submitted more than 30 contributions in the last 12 months, with 25 out of 30 being successfully evaluated and eventually approved; and has been logged into the BPA system on average four times per week in the last 12 months. The dynamic contribution relevancy (dcr) thus is computed as follows:

dcr(White, WELDING DOOR COMPONENTS) = viewingRate(White,
WELDING DOOR COMPONENTS) * collaborationRate(White) *
(approvalRate(White)−rejectionRate(White)) *
loginRate(White)=1*50*(25−5)*4=4000

Third, the Expert Ranker identifies Mr. White as a senior employee with a well-proven track record. All of his appraisal ratings in the last 5 years were at the 80th percentile, he has performed all trainings with exceptional results at the 90th percentile, and he has been in his senior role for 3.5 years now. The expert ranking (er) thus is computed as follows:

er(White)=timeCurrentRole(White)*lastAppraisalRating(White)*
educationalCompliance(White)=3.5*80*90=25200

Combining all three results leads to an automatic evaluation of Mr. White's contribution that is reflected by an above-average contribution ranking, e.g., in accordance with the following:

crk(White, WELDING DOOR COMPONENTS) = −25000 +
4000 + 25200 = 4200

This excellent ranking automatically triggers a workflow that pushes this Mr. White's proposal to the process owners' inbox as a very important and very relevant contribution.

It will be appreciated that as used herein, the terms system, subsystem, service, engine, module, programmed logic circuitry, and the like may be implemented as any suitable combination of software, hardware, firmware, and/or the like. It also will be appreciated that the storage locations, stores, and repositories discussed herein may be any suitable combination of disk drive devices, memory locations, solid state drives, CD-ROMs, DVDs, tape backups, storage area network (SAN) systems, and/or any other appropriate tangible non-transitory computer readable storage medium. Cloud and/or distributed storage (e.g., using file sharing means), for instance, also may be used in certain example embodiments. It also will be appreciated that the techniques described herein may be accomplished by having at least one processor execute instructions that may be tangibly stored on a non-transitory computer readable storage medium.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A computer system for improving a business process modeled in accordance with a modeling language, the computer system comprising:
processing resources including at least one processor and a memory operably coupled thereto;
a non-transitory computer readable storage medium tangibly storing a model object repository configured to store aspects of the business process, each aspect being modeled as an object in accordance with the modeling language; and
an electronic interface configured to receive contribution data, contribution data including data representative of a contribution corresponding to a proposed change to at least a part of the business process and an author of the contribution, contribution data being receivable from a plurality of different authors;
wherein the processing resources are configured to perform functionality comprising:
automatically and programmatically processing received contribution data by at least:
identifying, from the received contribution data, which object(s) from the model object repository is/are associated with the proposed change, and who the author of the contribution is;
computing, in accordance with a set of ranking rules, an individual contribution ranking for the contribution associated with the received contribution data, the ranking rules taking into account at least static and dynamic contribution relevancy as well as expertise of the author of the contribution, the static contribution relevancy being associated with a degree to which the author of the contribution is connected to the identified object(s), the dynamic contribution relevancy being associated with a degree to which the author of the contribution interacts with business process analysis software components; and
applying a set of action handling rules to determine, from a plurality of different possible computer-executable follow-up contribution events, a follow-up contribution event to be executed, the set of action handling rules taking into account at least the computed individual contribution ranking for the contribution associated with the received contribution data; and
selectively executing determined follow-up actions.

2. The system of claim 1, wherein for a given contribution the different possible computer-executable follow-up contribution events include events corresponding to automatic rejection of the given contribution, archival of the given contribution, transmission of data representative of the given contribution to a computer system of a manual reviewer, and/or automatic acceptance of the given contribution.

3. The system of claim 2, wherein the different possible computer-executable follow-up contribution events further include an event corresponding to transmission of data representative of the given contribution to a computerized platform by which a community of interested users can subject the given contribution to a community-based inspection procedure.

4. The system of claim 2, wherein the manual reviewer is identified as a business process owner and/or a business process object owner, based on metadata stored in and retrieved from the model object repository.

5. The system of claim 2, wherein the computer system of the manual reviewer is configured to order, in an inbox-like format, different contributions pending review, based on age and/or computed individual contribution rankings.

6. The system of claim 2, wherein individual contribution rankings are updatable for at least archived contributions, and wherein an update to a given individual contribution ranking is operable to cause the set of action handling rules to be re-applied.

7. The system of claim 1, wherein the set of ranking rules and/or the set of action handling rules is/are objectively determinable and dynamically user-configurable.

8. The system of claim 1, wherein for a given contribution:
(a) static contribution relevancy is based at least in part on a network distance between, and connection type for, the author of the given contribution and the identified objects(s); and
(b) dynamic contribution relevancy is based at least in part on how often the author of the given contribution has viewed the identified object(s) within a first time period, how many comments the author of the given contribution has posted within a second time period, how often the author of the given contribution has logged in to a business analysis system associated with the business process within a third time period, how often other contributions made by the author of the given contribution are approved and/or rejected within a fourth time period, and/or whether the author of the given contribution is an original for the identified object(s).

9. The system of claim 8, wherein for the given contribution:
(c) expertise of the author of the given contribution is based at least in part on an amount of time the author of the given contribution has spent in his/her current role, a last appraisal rating of the author of the given contribution, and/or educational level and/or compliance of the author of the given contribution.

10. The system of claim 1, wherein for the given contribution:
(c) expertise of the author of the given contribution is based at least in part on an amount of time the author of the given contribution has spent in his/her current role, a last appraisal rating of the author of the given contribution, and/or educational level and/or compliance of the author of the given contribution.

11. The system of claim 1, wherein expertise of the author is based at least in part on data obtained from an external human resources management system.

12. A non-transitory computer readable storage medium tangibly storing a program usable to improve a business process modeled in accordance with a modeling language, the program comprising instructions that, when executed by processing resources including at least one processor, are configured to perform functionality comprising:
interfacing with a model object repository configured to store aspects of the business process, each aspect being modeled as an object in accordance with the modeling language;
handling reception of contribution data including data representative of a contribution corresponding to a proposed change to at least a part of the business process and an author of the contribution, contribution data being receivable from a plurality of different authors;
automatically and programmatically processing received contribution data by at least:
identifying, from the received contribution data, which object(s) from the model object repository is/are associated with the proposed change, and who the author of the contribution is;
computing, in accordance with a set of ranking rules, an individual contribution ranking for the contribution associated with the received contribution data, the ranking rules taking into account at least static and dynamic contribution relevancy as well as expertise of the author of the contribution, the static contribution relevancy being associated with a degree to which the author of the contribution is connected to the identified object(s), the dynamic contribution relevancy being associated with a degree to which the author of the contribution interacts with business process analysis software components; and
applying a set of action handling rules to determine, from a plurality of different possible computer-executable follow-up contribution events, a follow-up contribution event to be executed, the set of action handling rules taking into account at least the computed individual contribution ranking for the contribution associated with the received contribution data; and
selectively executing determined follow-up actions.

13. The non-transitory computer readable storage medium of claim 12, wherein the different possible computer-executable follow-up contribution events include an event corresponding to transmission of data representative of the given contribution to a computerized platform by which a community of interested users can subject the given contribution to a community-based inspection procedure.

14. The non-transitory computer readable storage medium of claim 12, wherein for a given contribution the different possible computer-executable follow-up contribution events include events corresponding to automatic rejection of the given contribution, archival of the given contribution, transmission of data representative of the given contribution to a computer system of a manual reviewer, and/or automatic acceptance of the given contribution.

15. The non-transitory computer readable storage medium of claim 14, wherein the manual reviewer is identified as a business process owner and/or a business process object owner, based on metadata stored in and retrieved from the model object repository.

16. The non-transitory computer readable storage medium of claim 12, wherein the set of ranking rules and/or the set of action handling rules is/are objectively determinable and dynamically user-configurable.

17. The non-transitory computer readable storage medium of claim 12, wherein for a given contribution:
(a) static contribution relevancy is based at least in part on a network distance between, and connection type for, the author of the given contribution and the identified objects(s); and
(b) dynamic contribution relevancy is based at least in part on how often the author of the given contribution has viewed the identified object(s) within a first time period, how many comments the author of the given contribution has posted within a second time period, how often the author of the given contribution has logged in to a business analysis system associated with the business process within a third time period, how often other contributions made by the author of the given contribution are approved and/or rejected within a fourth time period, and/or whether the author of the given contribution is an original for the identified object(s).

18. The non-transitory computer readable storage medium of claim 17, wherein for the given contribution:
(c) expertise of the author of the given contribution is based at least in part on an amount of time the author of the given contribution has spent in his/her current role, a last appraisal rating of the author of the given contribution, and/or educational level and/or compliance of the author of the given contribution.

19. A method for improving a business process modeled in accordance with a modeling language, the method comprising:
interfacing with a model object repository configured to store aspects of the business process using processing resources including at least one processor, each aspect being modeled as an object in accordance with the modeling language;
handling reception of contribution data including data representative of a contribution corresponding to a proposed change to at least a part of the business process and an author of the contribution, contribution data being receivable from a plurality of different authors;
automatically and programmatically processing received contribution data, using the processing resources, by at least:
identifying, from the received contribution data, which object(s) from the model object repository is/are associated with the proposed change, and who the author of the contribution is;
computing, in accordance with a set of ranking rules, an individual contribution ranking for the contribution associated with the received contribution data, the ranking rules taking into account at least static and dynamic contribution relevancy as well as expertise of the author of the contribution, the static contribution relevancy being associated with a degree to which the author of the contribution is connected to the identified object(s), the dynamic contribution relevancy being associated with a degree to which the author of the contribution interacts with business process analysis software components; and
applying a set of action handling rules to determine, from a plurality of different possible computer-executable follow-up contribution events, a follow-up contribution event to be executed, the set of action handling rules taking into account at least the computed individual contribution ranking for the contribution associated with the received contribution data; and
selectively executing determined follow-up actions using the processing resources.

20. The method of claim 19, wherein the different possible computer-executable follow-up contribution events include an event corresponding to transmission of data representative of the given contribution to a computerized platform by which a community of interested users can subject the given contribution to a community-based inspection procedure.

21. The method of claim 19, wherein for a given contribution the different possible computer-executable follow-up contribution events include events corresponding to automatic rejection of the given contribution, archival of the given contribution, transmission of data representative of the given contribution to a computer system of a manual reviewer, and/or automatic acceptance of the given contribution.

22. The method of claim 21, wherein the manual reviewer is identified as a business process owner and/or a business process object owner, based on metadata stored in and retrieved from the model object repository.

23. The method of claim 19, wherein the set of ranking rules and/or the set of action handling rules is/are objectively determinable and dynamically user-configurable.

24. The method of claim 19, wherein for a given contribution:
(a) static contribution relevancy is based at least in part on a network distance between, and connection type for, the author of the given contribution and the identified objects(s); and
(b) dynamic contribution relevancy is based at least in part on how often the author of the given contribution has viewed the identified object(s) within a first time period, how many comments the author of the given contribution has posted within a second time period, how often the author of the given contribution has logged in to a business analysis system associated with the business process within a third time period, how often other contributions made by the author of the given contribution are approved and/or rejected within a fourth time period, and/or whether the author of the given contribution is an original for the identified object(s).

25. The method of claim 24, wherein for the given contribution:
(c) expertise of the author of the given contribution is based at least in part on an amount of time the author of the given contribution has spent in his/her current role, a last appraisal rating of the author of the given contribution, and/or educational level and/or compliance of the author of the given contribution.
